(19) United States
(12) Patent Application Publication
(10) Pub. No.: US 2019/0072238 A1
(43) Pub. Date: Mar. 7, 2019

(54) LED BULB WITH LARGE-ANGLE ILLUMINATION

(71) Applicants: Li Xin Thomas Li, Wan Chai (HK); Yi Yang, Changsha (CN); Zhongping Liu, Guangzhou (CN)

(72) Inventors: Li Xin Thomas Li, Wan Chai (HK); Yi Yang, Changsha (CN); Zhongping Liu, Guangzhou (CN)

(21) Appl. No.: 16/123,949

(22) Filed: Sep. 6, 2018

(30) Foreign Application Priority Data
Sep. 7, 2017 (CN) 201721143044.5

(51) Int. Cl. F21K 9/232; F21K 9/235; F21K 9/238; F21V 29/83; F21V 17/12; F21V 29/508; F21K 9/66; F21V 17/10; F21K 9/237; F21V 3/02; F21V 29/503; F21V 31/00

(52) U.S. Cl. CPC F21K 9/232; F21K 9/235; F21K 9/238; F21V 29/83; F21V 17/12; F21V 29/508; F21Y 2115/10; F21V 17/101; F21K 9/237; F21V 3/02; F21V 29/503; F21V 31/005; F21K 9/66

(57) ABSTRACT

A LED bulb with large-angle illumination includes a lamp cap, a lamp cover, an LED driver power supply, at least one LED and a heat conducting column, wherein the heat conducting column is hollow, and the LED driver power supply is built in the inner cavity of the heat conducting column; the LED is fixed to the outer surface of the heat conducting column and electrically connected to the LED driver power supply; one end of the heat conducting column is fixedly connected to the lamp cap, and the LED driver power supply is electrically connected to the lamp cap; and the lamp cover is disposed outside the heat conducting column and fixedly connected to the lamp cap to completely enclose the heat conducting column within the lamp cover. The irradiation capability of all LEDs is maximized, the irradiation angle is large, and the brightness is uniform.

### CROSS-REFERENCE TO RELATED APPLICATIONS

This application claims priority to Chinese Application No. CN 201721143044.5 having a filing date of Sep. 7, 2017, the entire contents of which are hereby incorporated by reference.

### FIELD OF TECHNOLOGY

The present invention relates to the field of LED lighting technology, and in particular relates to an LED bulb with large-angle illumination.

### BACKGROUND

A light emitting diode, abbreviated as LED, is made of a compound containing gallium (Ga), arsenic (As), phosphorus (P), nitrogen (N), or the like. It is a type of semiconductor diode, and can convert electrical energy into light energy. Like an ordinary diode, the light emitting diode is composed of a PN junction and also has unilateral conductivity. After a forward voltage is applied to the light emitting diode, holes injected from a P region into an N region and electrons injected into the P region from the N region are respectively recombined with the electrons in the N region and the holes in the P region within a few micrometers near the PN junction to generate fluorescence with spontaneous radiation. The energy states of electrons and holes in different semiconductor materials are different. The amount of energy released during the recombination of electrons and holes is different. The more energy is released, the shorter the wavelength of the emitted light is.

With the progress of LED lighting technology, LED lamps have gradually replaced incandescent lamps and energy-saving lamps in the traditional lighting field due to their advantages of energy conservation, long service life, environmental protection and the like, and have been accepted and recognized by people. However, most of the LED bulbs on the market are half-cover bulbs, as shown in FIG. 1, which is a structural diagram of an LED bulb in the prior art. Chinese patent No. 201620558943.0 discloses an LED bulb, including a lamp cap nut 100, a lamp holder 200 connected to the upper end of the lamp cap nut, an LED light source structure mounted in the lamp holder 200, and a light transmissive cover 300 fixedly disposed on the lamp holder 200, and further including a driving device disposed within the lamp holder 200 and electrically connected to the LED light source structure. In the LED bulb with the structure, the light transmissive cover 300 is hemispherical, and the LED light source structure is disposed in the lamp holder 200. During illumination, light can only be radiated through the hemispherical light transmissive cover 300, with a small angle and strong directivity of illumination, and is locally too bright, so that the eyes feel uncomfortable and are prone to visual fatigue. Nowadays, in the society where the quality of life is getting higher and higher, LED bulbs for lighting are required to be omnidirectional and also uniform in light intensity distribution. In 2009, the United States released a new standard for LED lighting. In the standard, the light intensity distribution of omnidirectional LED bulbs is required to be uniform and bright within the range of 270 degrees in the lateral and lower area of the bulb; and the luminous flux within the range of 90 degrees at the top shall not be too small. Therefore, there is still much room for improvement in the existing LED bulbs.

### SUMMARY

On this basis, the present invention aims at providing an LED bulb with large-angle illumination which is large in irradiation angle and uniform in brightness.

The LED bulb with large-angle illumination includes a lamp cap, a lamp cover, an LED driver power supply, at least one LED (Light Emitting Diode) and a heat conducting column, wherein the heat conducting column is hollow, and the LED driver power supply is built in the inner cavity of the heat conducting column; the LED is fixed to the outer surface of the heat conducting column and electrically connected to the LED driver power supply; one end of the heat conducting column is fixedly connected to the lamp cap, and the LED driver power supply is electrically connected to the lamp cap; and the lamp cover is disposed outside the heat conducting column and fixedly connected to the lamp cap to completely enclose the heat conducting column within the lamp cover. The LED of the LED bulb with the structure is welded to the heat conducting column, and as the heat conducting column is vertical within the internal space of the lamp cover, the LED is completely unshielded, so that the irradiation capability of all LEDs is maximized, the irradiation angle is large, and the brightness is uniform.

Further, the heat conducting column is cylindrical, and a plurality of LEDs are fixed to the cylindrical surface of the heat conducting column. Providing the LEDs on the surface of the heat conducting column in this shape can increase the light irradiation angle.

Further, the heat conducting column has a plurality of non-coplanar surfaces on the outside, and a plurality of LEDs are respectively fixed on the plurality of non-coplanar surfaces. Providing the LEDs on the surface of the heat conducting column in this shape allows the light to be irradiated to multiple angles.

Further, the bulb also includes a flexible PCB, the plurality of LEDs are welded on the flexible PCB, and the flexible PCB is applied to the outer surface of the heat conducting column and electrically connected to the LED driver power supply. The LEDs are connected through the flexible PCB, to facilitate installation and repair.

Further, the heat conducting column is provided with a through slot that communicates its inner cavity with the outside, and the LED driver power supply is electrically connected to the flexible PCB through a power line passing through the through slot. Further, the heat conducting column and the lamp cap are in threaded connection. The heat conducting column with this structure is easy to disassemble and assemble.

Further, the inner cavity of the heat conducting column is filled with thermal adhesive to seal the LED driver power supply within the heat conducting column. The thermal adhesive has excellent resistance to cold and hot alteration, aging resistance and electrical insulation, and has outstanding resistance to moisture, shock, corona, electrical leakage and chemical mediator. The heat conducting column filled with the thermal adhesive makes the bulb more durable.

Further, a closed end of the lamp cover is spherical, and an open end thereof extends away from the spherical center to form an opening connected to the lamp cap. The lamp cover with the structure allows the light irradiation angle of the LED to be larger.

Further, the lamp cover and the lamp cap are pressed together by a nailing machine. This configuration makes the connection between the lamp cover and the lamp cap more stable and firmer and not prone to loosening and releasing.

Compared with the prior art, the LED bulb with large-angle illumination of the present invention has the LEDs welded on the heat conducting column, and as the heat conducting column is vertical within the internal space of the lamp cover, the LEDs so configured are not shielded, so that the radiation angle of the light is wide, the brightness is uniform, the visual effect is comfortable and fatigue is not liable to occur; and the heat conducting column has both functions of supporting the LEDs and dissipating heat, so the LED bulb has a simple structure, low cost and long service life.

The present invention is described in detail below in conjunction with the drawings for better understanding and implementation.

### BRIEF DESCRIPTION OF THE DRAWINGS

FIG. 1 is a structural diagram of an LED bulb in the prior art;

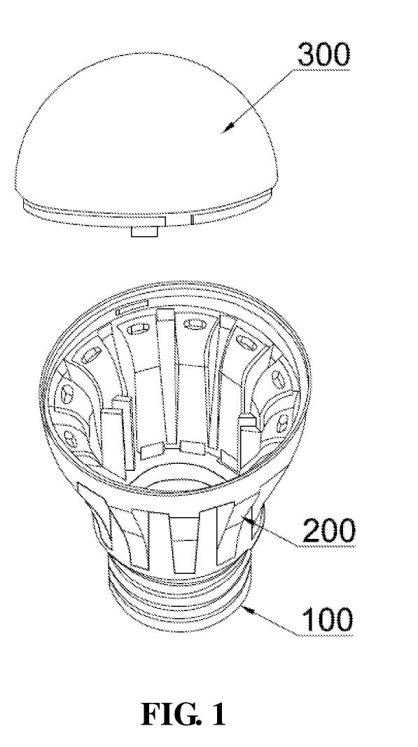

FIG. 2 is a structural diagram of embodiment 1 of an LED bulb with large-angle illumination of the present invention;

FIG. 3 is an exploded view of embodiment 1 of an LED bulb with large-angle illumination of the present invention;

FIG. 4 is a partial sectional view of a heat conducting column in embodiment 1;

FIG. 5 is a structural diagram of embodiment 2 of an LED bulb with large-angle illumination of the present invention; and

FIG. 6 is a partial sectional view of a heat conducting column in embodiment 2.

### DETAILED DESCRIPTION

Now referring to the following drawings, the present invention is described more fully. Embodiments of the present invention are shown in the drawings. However, the present invention can be embodied in various different forms, and should not be understood as limited to the particular embodiments set forth herein. Specifically, these embodiments are used for conveying the scope of the present invention to those skilled in the art.

Unless otherwise defined, the terms (including technical and scientific terms) used herein should be understood as having the same meanings as commonly understood by one of ordinary skill in the art to which the present invention pertains. Moreover, it is to be understood that the terms used herein should be understood as having meanings consistent with those in the present specification and the related art, and should not be interpreted in an ideal or overly formal sense unless so specified explicitly herein.

### Embodiment 1

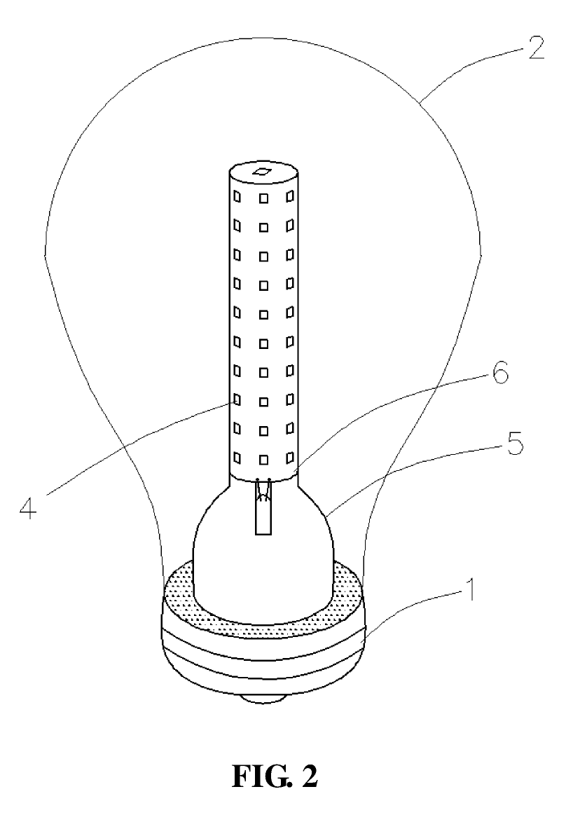

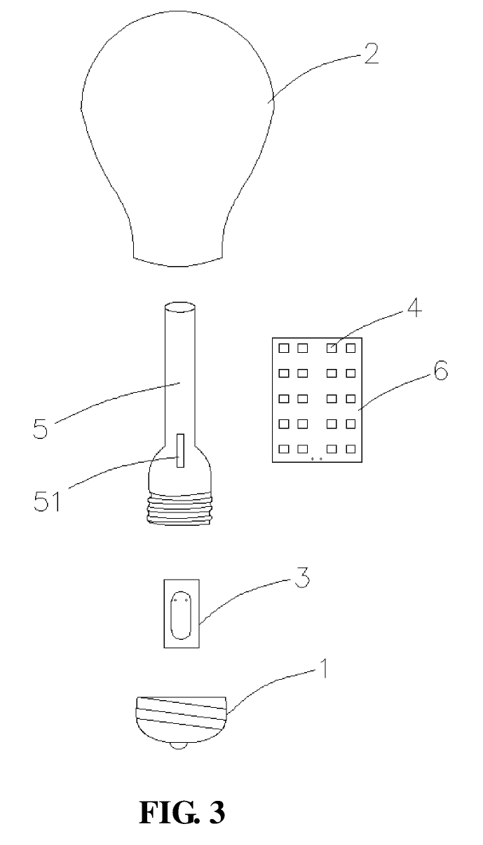

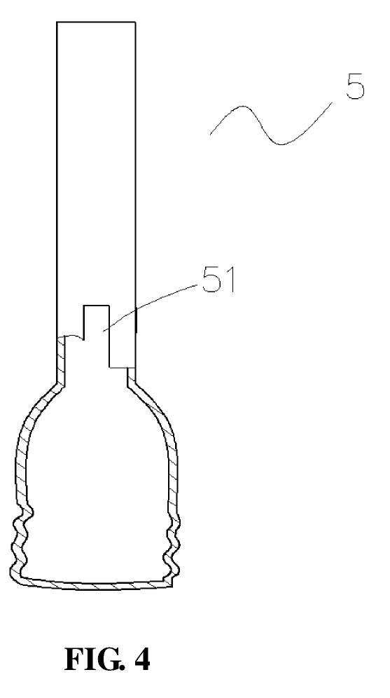

As shown in FIGS. 2, 3 and 4, FIG. 2 is a structural diagram of embodiment 1 of an LED bulb with large-angle illumination of the present invention, and FIG. 3 is an exploded view of embodiment 1 of the LED bulb with large-angle illumination of the present invention. The LED bulb with large-angle illumination includes a lamp cap 1, a lamp cover 2, an LED driver power supply 3, at least one LED (Light Emitting Diode) 4 and a heat conducting column 5, wherein the heat conducting column 5 is hollow, and the LED driver power supply 3 is built in the inner cavity of the heat conducting column 5; the LED 4 is fixed to the outer surface of the heat conducting column 5 and electrically connected to the LED driver power supply 3; one end of the heat conducting column 5 is fixedly connected to the lamp cap 1, and the LED driver power supply 3 is electrically connected to the lamp cap 1; and the lamp cover 2 is disposed outside the heat conducting column 5 and fixedly connected to the lamp cap 1 to completely enclose the heat conducting column 5 within the lamp cover 2. The LED 4 of the LED bulb with the structure is welded to the heat conducting column 5, and as the heat conducting column 5 is vertical within the internal space of the lamp cover 2, the LED 4 is completely unshielded, so that the irradiation capability of all LEDs 4 is maximized, the irradiation angle is large, and the brightness is uniform.

Specifically, the heat conducting column 5 is cylindrical, and a plurality of LEDs 4 are uniformly fixed to the cylindrical surface of the heat conducting column 5 including the top surface of the heat conducting column 5. The LEDs 4 uniformly distributed on the cylindrical surface are oriented to different angles respectively, so the LED lamp with the structure is large in irradiation angle and uniform in brightness.

Preferably, the present invention also includes a flexible PCB 6, a plurality of LEDs 4 are welded on the flexible PCB 6, and then the flexible PCB 6 is applied to the outer surface of the heat conducting column 5 and electrically connected to the LED driver power supply 3.

The heat conducting column 5 is provided with a through slot 51 that communicates its inner cavity with the outside, and the LED driver power supply 3 is electrically connected to the flexible PCB 6 through a power line passing through the through slot 51. With ingenious use of the inner cavity of the heat conducting column 5 and application of the flexible PCB 6, the circuit is simplified, and the internal space is saved, so that the internal structural design of the LED bulb is more concise and reasonable.

Preferably, the heat conducting column 5 and the lamp cap 1 are in threaded connection, and this connecting method facilitates disassemble and assembly of the heat conducting column 5 and improves the production efficiency. The inner cavity of the heat conducting column 5 is filled with thermal adhesive to seal the LED driver power supply 3 within the heat conducting column 5. A closed end of the lamp cover 2 is spherical, and an open end thereof extends away from the spherical center to form an opening connected to the lamp cap 1. The lamp cover 2 in this shape does not shield light rays emitted by the LEDs 4, so that the irradiation angle of the LED bulb is as large as possible. The lamp cover 2 and the lamp cap 1 are pressed together by a nailing machine, so that the bulb is more stable in structure and not prone to loosening and releasing, and the quality of the LED bulb is improved.

### Embodiment 2

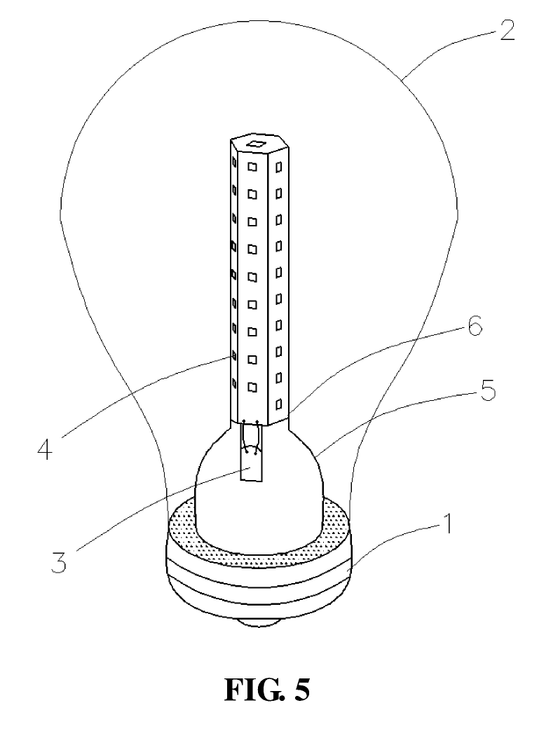

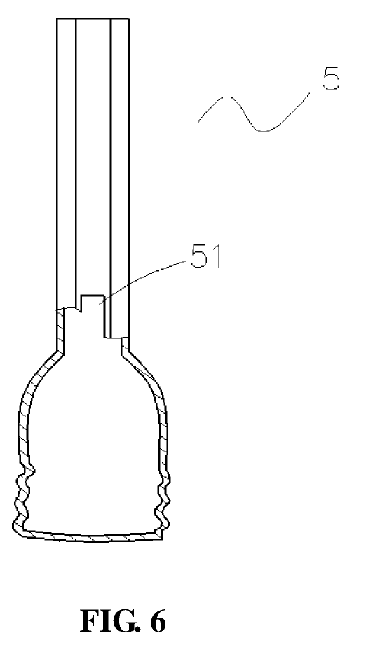

As shown in FIGS. 5 and 6, FIG. 5 is a structural diagram of embodiment 2 of an LED bulb with large-angle illumination of the present invention, and FIG. 6 is a partial sectional view of a heat conducting column in embodiment 2. The LED bulb with large-angle illumination includes a lamp cap 1, a lamp cover 2, an LED driver power supply 3, at least one LED (Light Emitting Diode) 4 and a heat conducting column 5, wherein the heat conducting column 5 is hollow, and the LED driver power supply 3 is built in the inner cavity of the heat conducting column 5; the LED 4 is fixed to the outer surface of the heat conducting column 5 and electrically connected to the LED driver power supply 3; one end of the heat conducting column 5 is fixedly connected to the lamp cap 1, and the LED driver power supply 3 is electrically connected to the lamp cap 1; and the lamp cover 2 is disposed outside the heat conducting column 5 and fixedly connected to the lamp cap 1 to completely enclose the heat conducting column 5 within the lamp cover 2. The LED 4 of the LED bulb with the structure is welded to the heat conducting column 5, and as the heat conducting column 5 is vertical within the internal space of the lamp cover 2, the LED 4 is completely unshielded, so that the irradiation capability of all LEDs 4 is maximized, the irradiation angle is large, and the brightness is uniform.

Specifically, the heat conducting column 5 has a plurality of non-coplanar surfaces on the outside, and the plurality of LEDs 4 are respectively fixed on the plurality of non-coplanar surfaces, including the top surface of the heat conducting column 5. The LEDs 4 uniformly distributed on the plurality of non-coplanar surfaces are oriented to different angles respectively, so the LED lamp with the structure is large in irradiation angle and uniform in brightness.

Preferably, the present invention also includes a flexible PCB 6, the plurality of LEDs 4 are welded on the flexible PCB 6, and then the flexible PCB 6 is applied to the outer surface of the heat conducting column 5 and electrically connected to the LED driver power supply 3.

The heat conducting column 5 is provided with a through slot 51 that communicates its inner cavity with the outside, and the LED driver power supply 3 is electrically connected to the flexible PCB 6 through a power line passing through the through slot 51. With ingenious use of the inner cavity of the heat conducting column 5 and application of the flexible PCB 6, the circuit is simplified, and the internal space is saved, so that the internal structural design of the LED bulb is more concise and reasonable.

Preferably, the heat conducting column 5 and the lamp cap 1 are in threaded connection, and this connecting method facilitates dissemble and assembly of the heat conducting column 5 and improves the production efficiency. The inner cavity of the heat conducting column 5 is filled with thermal adhesive to seal the LED driver power supply 3 within the heat conducting column 5. A closed end of the lamp cover 2 is spherical, and an open end thereof extends away from the spherical center to form an opening connected to the lamp cap 1. The lamp cover 2 in this shape does not shield light rays emitted by the LEDs 4, so that the irradiation angle of the LED bulb is as large as possible. The lamp cover 2 and the lamp cap 1 are pressed together by a nailing machine, so that the bulb is more stable in structure and not prone to loosening and releasing, and the quality of the LED bulb is improved.

In operation, the lamp cap 1 is connected to a power source, and the power is input to the LED driver power source 3 through the lamp cap 1 to drive the LEDs 4 welded on the flexible PCB 6. Due to the shape characteristic of the heat conducting column 5, the plurality of LEDs 4 are oriented to different angles, so that the LED bulb of the present invention is large in irradiation angle and uniform in brightness.

Compared with the prior art, the LED bulb with large-angle illumination of the present invention has the LEDs welded on the heat conducting column, and as the heat conducting column is vertical within the internal space of the lamp cover, the LEDs so configured are not shielded, so that the radiation angle of the light is wide, the brightness is uniform, the visual effect is comfortable and fatigue is not liable to occur; and the heat conducting column has both functions of supporting the LEDs and dissipating heat, so the LED bulb has a simple structure, low cost and long service life.

The embodiments described above only represent several implementations of the present invention, and the description thereof is relatively concrete and detailed, but it cannot be construed as limiting the patent scope of the invention. It should be noted that a number of modifications and improvements may be made by those of ordinary skill in the art without departing from the concept of the present invention, and these modifications and improvements are encompassed within the protection scope of the invention.

1. A LED bulb with large-angle illumination includes a lamp cap, a lamp cover, an LED driver power supply, at least one LED and a heat conducting column, wherein the heat conducting column is hollow, and the LED driver power supply is built in the inner cavity of the heat conducting column; the LED is fixed to the outer surface of the heat conducting column and electrically connected to the LED driver power supply; one end of the heat conducting column is fixedly connected to the lamp cap, and the LED driver power supply is electrically connected to the lamp cap; and the lamp cover is disposed outside the heat conducting column and fixedly connected to the lamp cap to completely enclose the heat conducting column within the lamp cover.

2. The LED bulb with large-angle illumination of claim 1, wherein the heat conducting column is cylindrical, and a plurality of LEDs are fixed to the cylindrical surface of the heat conducting column.

3. The LED bulb with large-angle illumination of claim 1, wherein the heat conducting column has a plurality of non-coplanar surfaces on the outside, and a plurality of LEDs are respectively fixed on the plurality of non-coplanar surfaces.

4. The LED bulb with large-angle illumination of claim 2, wherein the bulb also includes a flexible PCB, the plurality of LEDs are welded on the flexible PCB, and the flexible PCB is applied to the outer surface of the heat conducting column and electrically connected to the LED driver power supply.

5. The LED bulb with large-angle illumination of claim 3, wherein the bulb also includes a flexible PCB, the plurality of LEDs are welded on the flexible PCB, and the flexible PCB is applied to the outer surface of the heat conducting column and electrically connected to the LED driver power supply.

6. The LED bulb with large-angle illumination of claim 4, wherein the heat conducting column is provided with a through slot that communicates its inner cavity with the outside, and the LED driver power supply is electrically connected to the flexible PCB through a power line passing through the through slot.

7. The LED bulb with large-angle illumination of claim 5, wherein the heat conducting column is provided with a through slot that communicates its inner cavity with the outside, and the LED driver power supply is electrically connected to the flexible PCB through a power line passing through the through slot.

8. The LED bulb with large-angle illumination of claim 6, wherein the heat conducting column and the lamp cap are in threaded connection.

9. The LED bulb with large-angle illumination of claim 7, wherein the heat conducting column and the lamp cap are in threaded connection.

10. The LED bulb with large-angle illumination of claim 8, wherein the inner cavity of the heat conducting column is filled with thermal adhesive to seal the LED driver power supply within the heat conducting column.

11. The LED bulb with large-angle illumination of claim 9, wherein the inner cavity of the heat conducting column is filled with thermal adhesive to seal the LED driver power supply within the heat conducting column.

12. The LED bulb with large-angle illumination of claim 10, wherein a closed end of the lamp cover is spherical, and an open end thereof extends away from the spherical center to form an opening connected to the lamp cap.

13. The LED bulb with large-angle illumination of claim 11, wherein a closed end of the lamp cover is spherical, and an open end thereof extends away from the spherical center to form an opening connected to the lamp cap.

14. The LED bulb with large-angle illumination of claim 12, wherein the lamp cover and the lamp cap are pressed together by a nailing machine.

15. The LED bulb with large-angle illumination of claim 13, wherein the lamp cover and the lamp cap are pressed together by a nailing machine.
